(19) United States
(12) Patent Application Publication
(10) Pub. No.: US 2014/0016991 A1
(43) Pub. Date: Jan. 16, 2014

(54) Joint For The Transmission Of Torques And Axial Forces

(71) Applicants: Hisham Kamal, Waldkraiburg (DE); Stefan Weigl, Muehldorf am Inn (DE); Christian Bindig, Wunsiedel (DE)

(72) Inventors: Hisham Kamal, Waldkraiburg (DE); Stefan Weigl, Muehldorf am Inn (DE); Christian Bindig, Wunsiedel (DE)

(21) Appl. No.: 14/029,163

(22) Filed: Sep. 17, 2013

Related U.S. Application Data
(63) Continuation of application No. PCT/DE2012/000270, filed on Mar. 13, 2012.

(30) Foreign Application Priority Data
Mar. 17, 2011 (DE) 102011014284.3

(51) Int. Cl. F16D 1/00

(52) U.S. Cl. CPC F16D 1/00
USPC 403/23; 29/428

(57) ABSTRACT

The invention discloses a joint for the transmission of torques and axial forces in conjunction with an eccentric rotary motion. In a preferred embodiment, the joint according to the invention is used in an eccentric screw pump for connecting the drive to the pump rotor. The joint connects a coupling rod and a tool and/or a drive to one another. When the joint is used in an eccentric screw pump, the tool is the rotor of the pump. Furthermore, the joint is provided with at least one casing. The axial forces acting on the joint can be transmitted by a first joint part and the torques by a second joint part.

### FIELD OF THE INVENTION

The present invention relates to a joint, with which axial forces and torques can be transmitted or taken up in conjunction with eccentric rotary motions of pumps.

### BACKGROUND OF THE INVENTION

Swiss patent specification CH 446 913 relates to a protective device for the drive connection in the intake housing of an eccentric screw pump, said drive connection comprising articulated couplings and an articulated shaft. The drive connection is provided with a protective tube, wherein the protective tube is supported against co-rotation on the intake housing. In addition to the articulated shaft, other parts of the drive connection are also covered by the protective tube.

German patent application DE 198 43 333 A1 discloses a power transmission device capable of angular movements, comprising a housing and a spherical head capable of swivelling therein, said spherical head being connected in a non-rotational manner to the housing by means of a bolt penetrating said spherical head. The bore of the spherical head is widened in such a way that a cambered driver can be disposed in a sliding manner on the bolt, which driver follows the swivelling movements of the spherical head and is always adjacent with partial areas to the inner face of the bore in the presence of wobbling, eccentric or angular movements between the driven element and the drive unit. The support of the spherical head in the presence of axial thrusts takes place by means of a spherical cap disposed in a floating manner in the housing. The lateral guide of the driver in the bore, a simplified form of the driver, the sealing of the interior space of the device and the rear support of the spherical head in the presence of axial pull are described in further embodiments.

German patent specification DE 103 35 966 B3 discloses an eccentric screw pump with a drive, which is connected via an intermediate shaft to a rotor/stator combination. The intermediate shaft is connected, without the interposition of joints, both to the rotor and to the drive or a drive shaft. The cross-section of the intermediate shaft is reduced repeatedly, wherein the intermediate shaft comprises at least two webs disposed offset from one another and running normal to the longitudinal axis of the intermediate shaft. An intermediate wall is disposed between the webs.

The problem underlying the invention is to create a joint, with which torques and axial forces of a drive shaft can be transmitted in an economical, operationally reliable and uncomplicated manner to a machine and/or an eccentric screw pump.

### SUMMARY OF THE INVENTION

The above problem is solved by a joint for the transmission of torques and axial forces in conjunction with an eccentric rotary motion, wherein the joint connects a coupling rod, a tool and/or a drive and is provided with at least one casing. The transmission of torques and axial forces takes place without the use of elastomers. Further, the joint is configured such that the axial forces are transmitted by a first joint part and the torques by a second joint part, wherein the second joint part forms the casing. Other advantageous features can be derived from the sub-claims.

A further problem of the invention is to make available a method with which torques and axial forces of a drive shaft can be transmitted in an economical, operationally reliable and uncomplicated manner to a machine and/or an eccentric screw pump.

This problem is solved by a method involving a joint which connects a coupling rod, a tool and/or a drive and includes a first joint part and a second joint, the second joint part forming a casing for the joint, wherein the method comprises the steps of producing the second joint part from a torsionally stiff material, guiding the first joint part in the second joint part, taking up and/or transmitting axial forces by the first joint part, and transmitting torques by the second joint part. The joint is adapted to transmit the axial forces and torques without use of lubricants.

The invention discloses a joint for the transmission of torques and axial forces in conjunction with an eccentric rotary motion. In a preferred embodiment, the joint according to the invention is used in an eccentric screw pump for connecting a drive to a pump rotor. The joint connects a coupling rod and a tool or a drive to one another. When the joint is used in an eccentric screw pump, the tool is the rotor of the eccentric screw pump. Furthermore, the joint is provided with at least one casing. The force transmission essentially takes place without the use of elastomers and the axial forces acting on the joint can be transmitted and/or taken up by a first joint part and the torques by a second joint part, wherein the second joint part forms the casing.

In the preferred embodiment, the first joint part is a bending arm, a bolt or an additional joint, wherein the first joint part is disposed in the centre of the second joint part. The first joint part is produced from a flexurally stiff material and can have various geometrical design shapes. Furthermore, the material from which the first joint part is produced is elastic and freely rotatable. In a preferred embodiment, it is not possible to transmit torque with the first joint part. Furthermore, the first joint part can comprise a first part and a second part. The first part and the second part of the first joint part are connected to one another by a further joint. The additional joint is a ball-and-socket joint in a preferred embodiment.

The second joint part is a torsionally stiff casing for the joint, which is preferably constituted as a bellows or a membrane. The second joint part is produced from a metal, a plastic or a composite material. The material from which the casing is produced is to be selected such that it is flexible despite its torsional stiffness. In the preferred embodiment, it is not possible to transmit axial forces with the casing. In a further embodiment, the second joint part has a multi-part design. In the case of the multi-layered embodiment, joint parts made of the same or different materials can be used.

The tool and/or the drive are connected to the joint by a hydraulic clamping element. It is clear to a person skilled in the art that, instead of the hydraulic clamping elements, use may be made of the most diverse elements that are suitable for connecting the joint, for example, to a tool. The hydraulic clamping element represents a detachable, friction-locked connection.

Furthermore, a method for the use of a joint according to the invention is disclosed, wherein the first joint part is guided in a second joint part. Axial forces are taken up and/or transmitted by the first joint part. Due to the fact that the second joint part is produced from a torsionally stiff material, it is possible with the latter to implement the transmission of torques. By means of the casing of the mobile parts, it is possible to use the joint according to the invention with or without lubricant. This brings considerable advantages, for example, with respect to the use of an eccentric screw pump in the area of conveying food stuff, since food products can no longer be contaminated with lubricant when use is made of the joint according to the invention.

As a result of the use of the hydraulic clamping element, the tool and/or the drive are connected by means of a threadless connection to the joint. The first joint part is produced from various materials. Furthermore, it is possible for the first joint part to comprise a first part and a second part and for the first part and the second part to be connected by means of a further joint.

No elastomers are used in the joint according to the invention. As a result, fewer problems arise with the resistance to aggressive media. A further advantage lies in the fact that media are handled in a much larger temperature range. Furthermore, there is the possibility of protecting the outer intermediate spaces of the second joint part against the penetration of foreign bodies. This protection can comprise a casing which is disposed around the second joint part. Furthermore, it is possible for the outer intermediate spaces of the second joint part to be filled with an elastomer foam. This elastomer and/or the casing prevents small parts from getting into the proximity of the joint and/or into the outer intermediate spaces of the second joint part and prevents damaging the latter.

In the following, examples of embodiment are intended to explain the invention and its advantages in greater detail with the aid of the appended figures. The size ratios of the individual elements with respect to one another in the figures do not always correspond to the actual size ratios, since some shapes are represented simplified and other shapes, for the sake of greater clarity, are represented magnified in relation to other elements.

### BRIEF DESCRIPTION OF THE DRAWINGS

FIG. 1 shows the diagrammatic structure of the joint according to the invention.

FIG. 2 shows, diagrammatically, the structure of a joint with a profiled first joint part.

FIG. 3 shows, diagrammatically, the structure of a joint with a two-part first joint part and an additional joint.

FIG. 4 shows a joint wherein the outer intermediate spaces of the second joint part are filled with an elastomer.

### DETAILED DESCRIPTION OF THE INVENTION

FIG. 1 shows the diagrammatic structure of joint 10 according to the invention. Joint 10 comprises a first joint part 12, which is surrounded by a second joint part 14. Disposed on the side lying opposite coupling rod 18 is a hydraulic clamping element 16, with which joint 10 can be connected to a tool 20 or a drive (not represented). Tool 20 is the rotor of an eccentric screw pump in FIG. 1.

Hydraulic clamping element 16 is a clamping bush known from the prior art. Hydraulic clamping element 16 is pushed onto an articulated shaft 30. Tool 20 or the drive is applied on wall 17 of clamping element 16. As a result of turning an adjusting screw (not represented), wall 17 expands and is pressed against tool inner wall 32. As a result of the expansion of wall 17, hydraulic clamping element 16 is connected in a detachable and friction-locked manner to articulated shaft 30 and tool inner wall 32.

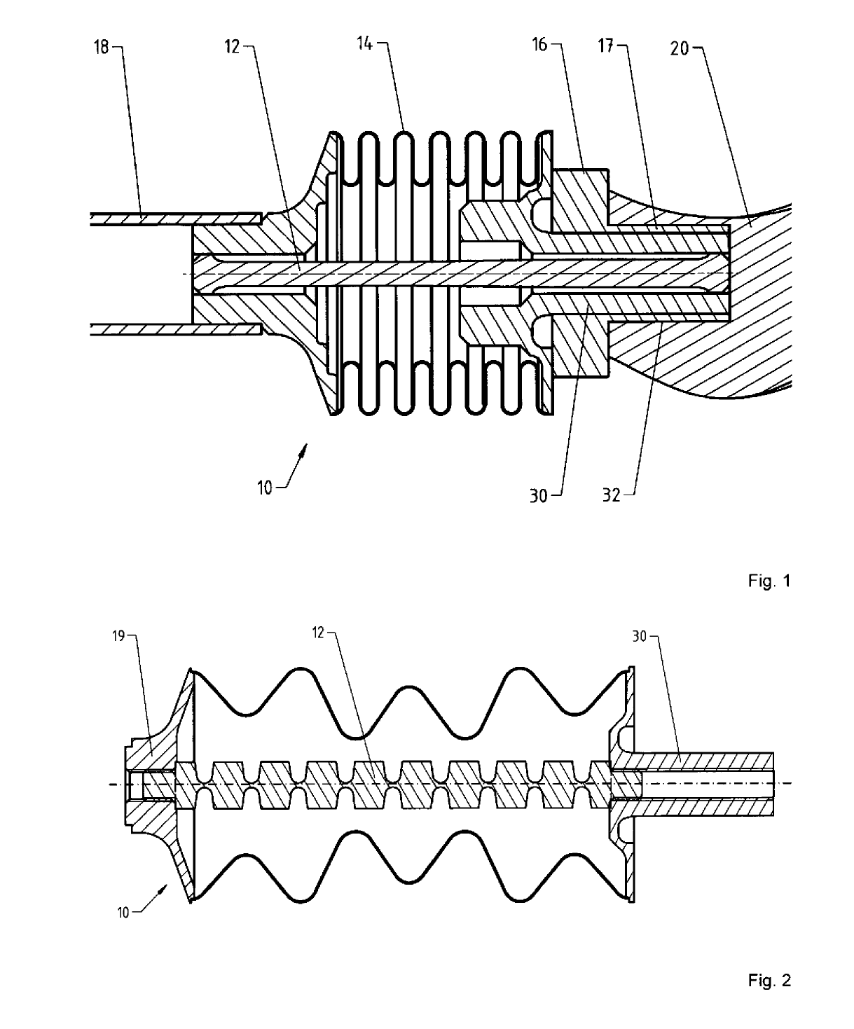

FIG. 2 shows, diagrammatically, the structure of a joint 10 with a profiled first joint part 12. As a result of this profiling, it is possible to improve the bending properties in the transition of the vertical deflection into the horizontal deflection. This improved behaviour can also be brought about by a groove-shaped constriction (not represented) in first joint part 12. The elasticity is again increased by the introduction of an additional groove-shaped constriction. In the case of this first joint part 12, groove-shaped constrictions are introduced at specific distances from one another, which do not influence the strength of first joint part 12, but represent a saving on material. Furthermore, the restoring forces are reduced by the groove-shaped constrictions in first joint part 12. In order to accommodate modified first joint part 12, connection 19 to the coupling rod (not represented) and articulated shaft 30 have been adapted, compared to FIG. 1, to the requirements.

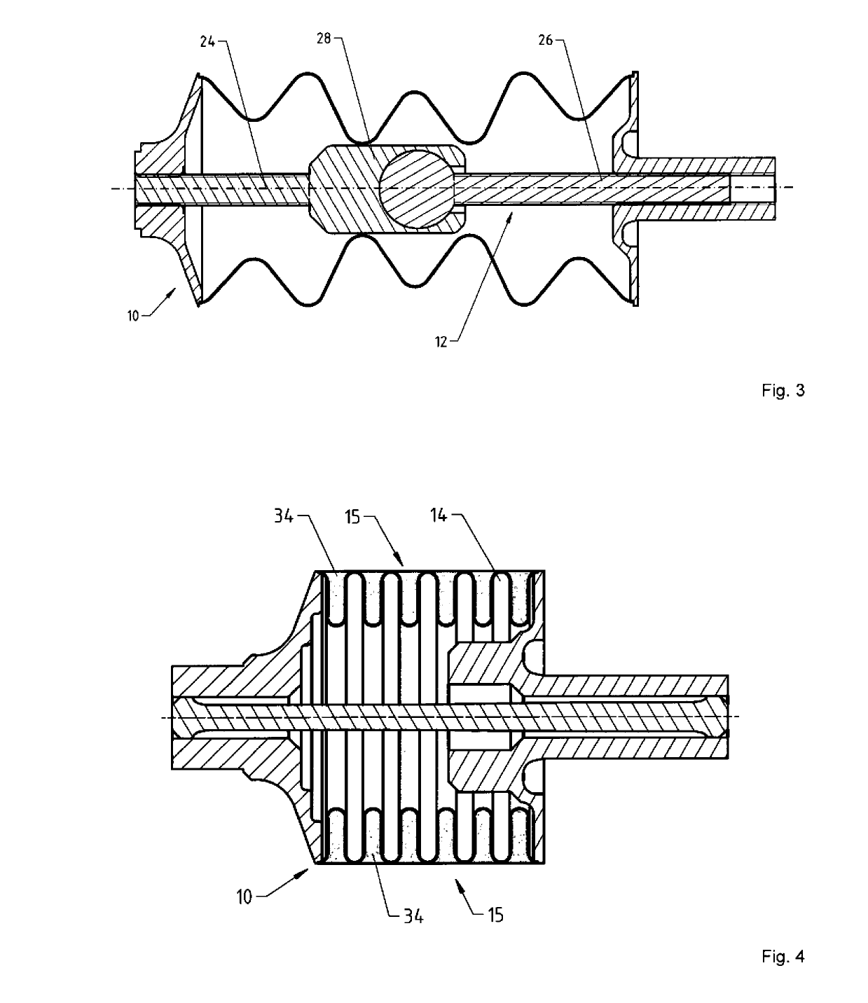

FIG. 3 shows, diagrammatically, the structure of a joint 10 with a two-part first joint part 12 and additional joint 28. First joint part 12 comprises, to take up additional forces in this example of embodiment, a first part 24 and a second part 26. First part 24 and second part 26 are connected to one another by means of an additional joint 28.

FIG. 4 shows a joint 10, wherein outer intermediate spaces 15 of second joint part 14 are filled with an elastomer 34. This elastomer 34 is suitable for restraining particles that could penetrate into outer intermediate spaces 15. Employed elastomer 34 is subjected to the influence of various conveying media, but since it does not perform any sealing or motion-related functions, swelling or a chemical change in the elastomer at this point of joint 10 is not problematic and therefore negligible.

First joint part 12 is represented as a bending arm and second joint part as a bellows in FIGS. 1 to 4. No conclusive limitation of the invention emerges from these embodiments for the person skilled in the art. Many devices and methods are known from the prior art in this regard for taking up torques and/or axial forces.

The invention has been described by reference to a preferred embodiment.

1. A joint for transmission of torques and axial forces in conjunction with an eccentric rotary motion, wherein the joint connects a coupling rod, a tool and/or a drive, the joint comprising:
a first joint part for transmitting axial forces;
a second joint part for transmitting torques; and
at least one casing, wherein the second joint part forms the casing;
characterised in that the first joint part and the second joint part are adapted to transmit the axial forces and torques without use of elsatomers.

2. The joint according to claim 1, characterised in that the first joint part comprises a bending arm, a bolt or an additional joint and that the first joint part is disposed in the center of the second joint part.

3. The joint according to claim 2, characterised in that the first joint part is produced from a flexurally stiff material.

4. The joint according to claim 2, characterised in that the first joint part has various geometrical design shapes.

5. The joint according to claim 2, characterised in that the first joint part comprises a first part and a second part.

6. The joint according to claim 5, characterised in that the first joint part and the second part of the first joint part are connected by a further joint.

7. The joint according to claim 1, characterised in that the second joint part is a torsionally stiff casing for the joint, wherein the second joint part is configured to be multi-layered.

8. The joint according to claim 7, characterised in that the second joint part is produced from a metal, a plastic or a composite material.

9. The joint according to claim 7, characterised in that outer intermediate spaces of the second joint part are protected against penetration of foreign bodies.

10. The joint according to claim 10, characterised in that the outer intermediate spaces of the second joint part are filled with an elastomer.

11. The joint according to claim 1, characterised in that the tool and/or the drive are connected to the joint by means of a hydraulic clamping element.

12. The joint according to claim 11, characterised in that the hydraulic clamping element provides a detachable, friction-locked and form-fit connection.

13. A method of using a joint according to claim 1, characterised in that
the first joint part is guided in a the second joint part;
axial forces are taken up and/or transmitted by the first joint part;
the second joint part is produced from a torsionally stiff material and that torques are transmitted by the second joint part and
the first joint part and second joint part are adapted to transmit the axial forces and torques without lubricants in the joint.

14. The method according to claim 13, characterised in that the tool and/or the drive are connected threadless to the joint by means of a hydraulic clamping element.

15. The method according to claim 13, characterised in that the first joint part is produced from various materials.

16. The method according to claim 13, characterised in that the first joint part comprises a first part and a second part, and that the first part and the second part are connected by a further joint.

17. The joint according to claim 7, wherein the second joint part comprises a bellows or a membrane.
